(19) United States
(12) Patent Application Publication
(10) Pub. No.: US 2010/0058378 A1
(43) Pub. Date: Mar. 4, 2010

(54) COMPUTER-COST SUBSIDIZING METHOD

(76) Inventor: Marc Feldman, Beachwood, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/549,585

(22) Filed: Aug. 28, 2009

Related U.S. Application Data
(60) Provisional application No. 61/092,865, filed on Aug. 29, 2008.

(51) Int. Cl. H04N 7/16; H04N 7/025

(52) U.S. Cl. 725/23; 725/34; 725/109

(57) ABSTRACT

A computer-cost subsidizing method wherein an interface medium (30) targets commercial advertisements for each household (10) based on, and consistent with, that household's television-viewing profile. The targeted advertisements are chosen from a pool of promotions provided by a plurality of commercial enterprises (40). The money paid by the commercial enterprises (40) for such advertisements subsidizes the cost of a computer (60) supplied to the household (10). The computer (60) participates in the monitoring of control options reflecting household-viewing preferences used by the interface medium (30) for ad-targeting purposes.

### RELATED APPLICATION

This application claims priority under 35 U.S.C. §119(e) to U.S. Provisional Patent Application No. 61/092,865 filed on Aug. 29, 2008. The entire disclosure of this provisional patent application is hereby incorporated by reference.

### BACKGROUND

Almost all households (e.g., 99%) in the United States have at least one television set. At the same time, only roughly half of these households have a working computer with internet access. Ironically, while household televisions are believed to contribute very little to academic and intellectual advancement, the opposite is true of computers. In today's technical world, computer-less households are at a distinct disadvantage in educational arenas and professional provinces. Needless to say, the issue is money. The cost of even a remedial computer is often out of financial reach for low-income families.

### SUMMARY

A method is provided which allows commercial enterprises to effectively target advertisements by profiling a household's personality based on television-viewing selections. And the moneys paid by the commercial enterprises for such advertising can be used to subsidize the cost of household computers. The method involves the interconnection between a computer and a television in a household, wherein the computer interfaces with a remote medium that coordinates the targeted advertising campaign.

The timing for this invention could not be better. All major stations are now broadcasting only digital-signal streams, whereby analog-receiving televisions are no longer be functional without additional equipment. Converter boxes are currently being offered as quick fix solutions, and they are expected to be blindly adopted by many households. But the bottom line is that everyone without a recently-purchased expensive television will have to do something. Thus even households with a “don't-fix-unless-its-broke” mentality will have to face their technology fears and update television operations.

The computer used in the method/system of the present invention can serve as, or in conjunction with, a converter. And the computer can be pre-programmed to supply, in a non-intimidating manner, the bells-and-whistles features found on expensive/complex video equipment. And speaking of expensive/complex equipment, the present invention works quite well with the old “obsolete” televisions buried in basements and attics.

### DRAWINGS

FIG. 1 is a schematic diagram of a targeted advertising system according to the present invention.

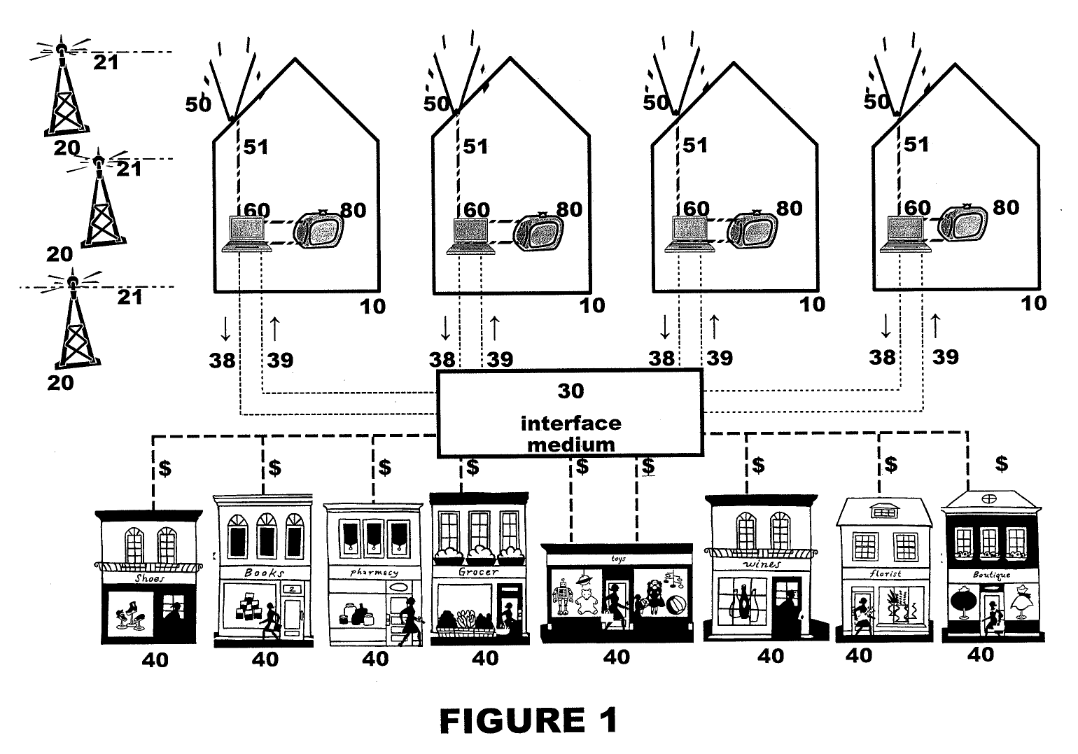

FIG. 2 is a schematic diagram of method of using the targeted advertising system.

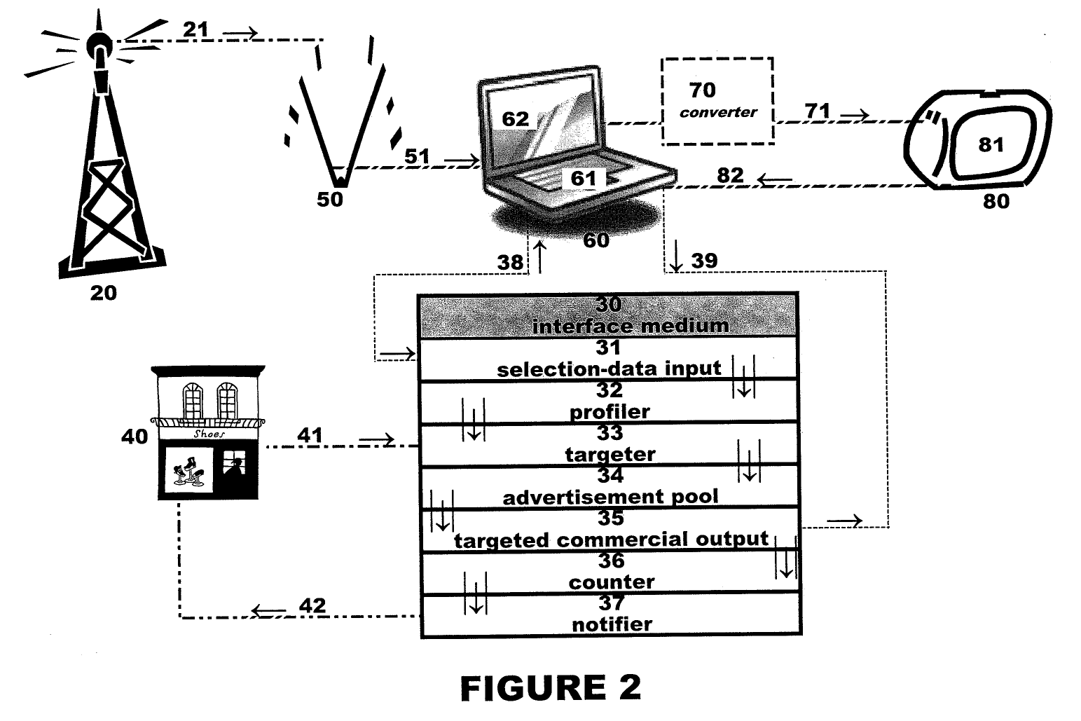

### DETAILED DESCRIPTION

Referring now to the drawings, a targeted advertising system is schematically shown. The system comprises a plurality of households 10, a plurality of broadcasting stations 20, an interface medium 30, and a plurality of commercial enterprises 40. Each household 10 has a receiver 50, a computer 60, and a television set 80 interconnected with the computer 60.

The household 10 receives streams of visual-presentation signals 21 from the broadcast stations 20 via its receiver 50, which then transfers the received signals 51 to the computer 60. At the household 10, certain signal streams are selected at given times corresponding to preferred visual presentations. These preferred visual presentations are viewed on screen 81 of the television set 80.

The interface medium 30 chooses targeted commercial advertisements based on and consistent with the preferred-presentation data of the household. The commercial enterprises 40 collectively provide commercial advertisements 96 to a pool 34 (e.g., via internet connection 41). And the moneys paid by the commercial enterprises 40 for the display of their commercial advertisements are used to subsidize the cost of the computer 60. For example, the full cost of the computer 60 can be fully subsidized or partially subsidized (e.g., up to about 50%, up to about 60%, up to about 70%, up to about 80%, and/or up to about 90%) by the advertisement money paid by the commercial enterprises 40. Additionally or alternatively, this advertisement money can enable the household 10 to receive a rebate for the cost of the computer 60.

The interface medium 30 is situated remote from the households 10, and it can comprise a selection-data input 31, a profiler 32, a targeter 33, a pool 34 of advertisements, and an output 35. A household's selection of signal streams at given times can be provided (e.g., via an internet connection 38) through the input 31, and the profiler 32 can compile the selections and determine a preferred-presentation. The profiling step can be, for example, a function of broadcasting station selections made by the household 10. The targeter for chooses targeted commercial advertisements from the electronically-stored pool 34 based on preferred-presentation profiles. An output 35 for sends (e.g., via an internet connection 39) the targeted commercial advertisements to the computer 60 of each household 10 for display on the interconnected television set 80.

The interface medium 30 can further comprise a counter 36 for counting the number of times each commercial advertisement is chosen and sent for display on a television set 80 in a particular household 10. A notifier 37 can be employed to notify (e.g., via internet connection 42) a commercial enterprise 40 that its advertisement has been chosen and sent to a household 10.

The signals 21/51 can be digital signals which are converted to analog signals 71 upstream of the television set 80. This converting step can be performed by the computer 60. Or this conversion can be performed outside the computer 60 by, for example, a separate converter 70.

The presentation-preference data of one or more household 10 can also be used to compile community-preference data for other (e.g., similar) households 10.

The visual-presentation selecting step can comprise the household selecting one channel of a plurality of signal streams 21/51/71 received at a given time. Additionally or alternatively, the selecting step can comprise recording the selected visual presentation at the given time and viewing on the television set 80 at a later time. For example, the stream of signals 21/51/71 corresponding to the selected visual presentation could be stored in the computer 60 for later viewing, when the computer is instructed to send the stored signals stream to the television set 80.

The visual-presentation selecting step can also comprise the computer 60 to temporarily storing a predetermined window of the signal-stream 21/51/71 and with a delay corresponding to this window. The signals could be continuously sent to the television set 80 at a constant viewing rate unless instructed otherwise at the household 10. These sending/viewing steps could comprise storing the signal stream 21/51 in the computer 60 as a received digital signal and sending a converted analog-signal stream 71 to the television set 80 at a later time.

The selecting step can further comprise instructing the computer 60 to reverse the sending of the signals to the television set 80 and/or to fast-forward the sending of the signals to the television set 80. A fast-forward instruction can be used as a negative indicator in the presentation-preference data, as it reflects non-interest in such presentation. And/or the selecting step could comprise instructing the computer 60 to pause the sending of the signals 71 to the television set 80.

The computer 60 can comprises an alphabetic-numeric input board 6) and an output screen 62. It can be used independently of the television set 80. In other words, the system does not require a dedicated computer 60.

One may now appreciate the present system/method allows commercial enterprises to effectively target advertisements by profiling a household's personality based on television-viewing selections. And the moneys paid by the commercial enterprises for such advertising can be used to subsidize the cost of household computers.

1. A method for subsidizing the cost of a computer with money paid for the display of commercial advertisements, said method comprising:
receiving, in a household with a television set interconnected with the computer, streams of visual-presentation signals from broadcast stations,
inputting the received visual-presentation signals into the computer at the household,
selecting, at the household, certain signal streams at given times corresponding to preferred visual presentations,
viewing the preferred visual presentations on the television set,
displaying targeted commercial advertisements on the television set;
wherein an interface medium, remote from the household, monitors the selecting steps performed at the household to compile preferred-presentation data;
wherein the interface medium chooses the targeted commercial advertisements from a pool of commercial advertisements, this choice being based on and consistent with the preferred-presentation data of the household;
wherein the pool of commercial advertisements are provided by a plurality of commercial enterprises which pay moneys for the display of such advertisements to the household; and
wherein the moneys paid by the commercial enterprises for the display of the commercial advertisements are used to subsidize the cost of the computer.

2. A method as set forth in claim 1, wherein the received stream of visual-presentation signals are digital signals.

3. A method as set forth in claim 1, wherein the visual-presentation signals sent to the television set for visual display of the preferred visual presentations are analog signals.

4. A method as set forth in claim 3, further comprising the step of converting the received stream of visual-presentation signals into analog signals prior to said viewing step.

5. A method as set forth in claim 4, wherein said converting step is performed by the computer.

6. A method as set forth in claim 4, wherein said converting step is performed outside of the computer.

7. A method as set forth in claim 1, wherein the selecting step comprises selecting one channel of a plurality of signal streams received at a given time.

8. A method as set forth in claim 1, wherein the computer comprises an alphabetic-numeric input board and an output screen which can be used independently of the television set.

9. A method as set forth in claim 8, wherein the targeted commercial advertisements are sent from the interface medium to the computer via an internet connection.

10. A method as set forth in claim 1, wherein data corresponding to the preferred visual presentation is sent to the interface medium via an internet connection.

11. A method as set forth in claim 1 wherein the cost of the computer is partially subsidized by the money paid by the commercial enterprises for the display of the commercial advertisements.

12. A method as set forth in claim 1 wherein the household receives a rebate for the cost of the computer.

13. A method as set forth in claim 1, wherein the household is subsidized for its internet connection by the money paid by the commercial enterprises for the display of the commercial advertisements.

14. A method as set forth in claim 1 wherein the selecting step comprises selecting visual presentations for viewing at the given time.

15. A method as set forth in claim 1 wherein the presentation-preference data of the household is used to compile community-preference data for other households.

16. A method of viewing a visual presentation broadcast in a stream of digital signals at a household 10 with a television set that displays visual presentations from a stream of analog signals; said method comprising;
receiving a digital-signal stream from a broadcast station;
inputting the received digital-signal stream into a computer at the household;
converting the digital-signal stream into an analog-signal stream;
sending the analog-signal stream to the television set; and
viewing the visual presentation generated by the analog-signal stream on the television set.

17. A method as set forth in claim 16, wherein the computer comprises an alphabetic-numeric input board and an output screen, and wherein the method further comprises the step of using the computer independently from the television set.

18. A method as set forth in claim 16 wherein said sending/viewing steps comprise storing the signal stream (91) in the computer (60) as the digital signal (90) is received and sending the converted analog-signal stream (92) to the television set (80) at a later time.

19. A targeted advertising system comprising:
a plurality of households, each having a receiver, a computer, and a television set interconnected with the computer,
a plurality of broadcasting stations, each broadcasting a stream of visual-presentation signals which are received by the household's receiver;
an interface medium, remote from the households, that compiles a preferred-presentation profile for each household, and sends targeted commercial advertisements to each household for viewing on its television set, wherein the targeted commercial advertisements are chosen for each household based on and consistent with its preferred-presentation profile.
a plurality of commercial enterprises which collectively provides a pool of commercial advertisements from which the targeted commercial advertisements can be chosen, and which each pay money for the interface medium to send its advertisements to the households.

20. A targeted advertising system as set forth in claim 19, wherein the interface medium comprises:
a selection-data input through which each household's selection of signal streams at given time can be provided;
a profiler which compiles the households' selections and determines a preferred-presentation profile for each household;
a pool of commercial advertisements electronically stored;
a targeter for choosing targeted commercial advertisements from the pool (34) based on preferred-presentation profiles,
an output for sending the targeted commercial advertisements to the computer of each household for display on the interconnected television set.
